(19) United States
(12) Patent Application Publication
(10) Pub. No.: US 2026/0303214 A1
(43) Pub. Date: Oct. 1, 2026

(54) Telecom-Photon Insensitive Superconducting Qubit to Transducer Module

(71) Applicant: Booz Allen Hamilton Inc., McLean, VA (US)

(72) Inventors: Michael Senatore, Syracuse, NY (US); Erin Sheridan, Oneida, NY (US); Daniel Campbell, Clinton, NY (US); Matthew LaHaye, Manlius, NY (US); Stephen McCoy, Rome, NY (US); Samuel Schwab, Clinton, NY (US); Alaina Attanasio, West Lafayette, IN (US); Hao Tian, West Lafayette, IN (US); Sunil Bhave, West Lafayette, IN (US); Yuvraj Mohan, Berkeley, CA (US)

(73) Assignee: Booz Allen Hamilton Inc., McLean, VA (US)

(21) Appl. No.: 19/631,083

(22) Filed: Mar. 27, 2026

Related U.S. Application Data
(60) Provisional application No. 63/778,752, filed on Mar. 27, 2025.

(51) Int. Cl. H04B 10/2507; H04B 10/70

(52) U.S. Cl. CPC H04B 10/2507; H04B 10/70

(57) ABSTRACT

The present disclosure describes improved quantum systems, and processing thereof, that may comprise optimized transducer assembly configurations to enhance the conversion of quantum information between quantum processors and carriers for physical interactions. For ease of explanation, an exemplary transducer is a photon-insensitive transducer, but the present disclosure is not so limited. An exemplary photon-insensitive transducer module comprises a superconducting circuit, an optomechanical transducer, and a coupling circuit. The optomechanical transducer is arranged to mediate an exchange between telecom-wavelength optical modes and a microwave frequency mechanical mode. The coupling circuit is arranged to mediate coupling between the superconducting circuit and the optomechanical transducer. Each of the superconducting circuit, the optomechanical transducer, and the coupling circuit may be arranged and connected as independent modules. Each module may include one or more mitigating structures for protecting the superconducting circuit from carrier particle interaction.

### RELATED APPLICATION

This application claims priority to U.S. Patent Application No. 63/778,752 filed on Mar. 27, 2025, the entire content of which is hereby incorporated by reference.

### GOVERNMENT FUNDING

This invention was made with government support under FA8750-23-2-0007 awarded by U.S. Department of Defense. The government has certain rights in the invention.

### FIELD

The present disclosure relates to improvements in quantum computing comprising optimized transducer assembly configurations.

### BACKGROUND

As an example for illustrating technical challenges faced, superconducting quantum bit (qubit) devices have become a frontrunner in the quantum information industry, boasting good lifetimes, fast gates, some of the highest gate fidelities, and the deepest device connectivity of all qubit modalities to date. As such, these devices are a top pick for any application that requires fast preparation or high coupling strengths, and come paired with easy access to extremely application-flexible, on-chip, ancillary superconducting circuitry that can be designed to serve a host of different applications. The entire quantum information community strives to scale up and network quantum (e.g., qubit) devices so that quantum computation of non-trivial problems, high-speed, ultra-secure quantum communication, and quantum enhanced sensor networks become tractable. To achieve scalability or to facilitate quantum information transmission, distant connections between separate quantum (e.g., qubit) devices are necessary. Long distance transmission of signals carrying quantum information can only be performed in transmission media that have low attenuation per unit distance, but the native regime of the superconducting quantum device is the microwave regime, which does not satisfy this condition. Consequently, transducers capable of taking microwave signals from a superconducting qubit and coherently converting them for long-distance transmission would be of great benefit to the community.

Challenges persist in that superconducting circuits are extremely sensitive to pair-breaking radiation in the infrared spectrum. Infrared photons impinging upon superconducting material can break superconducting charge carriers (e.g., Cooper pairs) into normally-conducting quasiparticles (electrons). These quasiparticles can then inelastically scatter off each other, and off atomic nuclei which make up the material lattice, thereby emitting phonon excitations (discrete wave-packets of vibration) which can persist for long periods before colliding with and breaking apart other Cooper pairs, thereby generating more quasiparticles. The presence of these initial quasiparticles and their resulting phonon excitations can give rise to a long-lived population of quasiparticles which can degrade superconducting qubit performance for periods of time that are on the same order as the qubit lifetime. Ordinarily, superconducting qubit researchers exert herculean effort to block all infrared photons from reaching their devices whatsoever, but the need to interface superconducting devices with transducers demands technical solutions that bring these photons directly into the space that a quantum device (e.g., qubit device) occupies.

### SUMMARY

The present provides improved quantum systems, and processing thereof, that comprises optimized transducer configurations to enhance the conversion of quantum information between quantum processors (e.g., superconducting qubit working off microwave signals) and carriers for physical interactions (e.g., photons, electrons, phonons, magnons, ions). For ease of explanation, an exemplary transducer is a photon-insensitive transducer, but the present disclosure is not so limited.

An exemplary transducer module may comprise a quantum processor (e.g., superconducting circuit), an exemplary transducer (e.g., optomechanical transducer), and a coupling circuit. In other quantum system configurations, one or more components may vary depending on the desired configuration and practical use case. An exemplary transducer (or transducer module) may mediate conversion of data between forms without destroying quantum properties (e.g., superposition and entanglement) such that quantum states are converted into carrier forms (and vice-versa). In the case of quantum communications, optical photons may be utilized (e.g., via fiber optics), but conversion is required as quantum processors (e.g., superconducting qubits) leverage microwave signals (e.g., microwave photons), which are sub-optimal for long-distance communication.

In some non-limiting examples, an exemplary photon-insensitive transducer module is disclosed. The transducer module comprising: optical fibers configured for communicating with an external device; at least one superconducting circuit configured for generation, manipulation, and readout of qubit-state information; an optomechanical transducer coupled to the optical fibers and configured to mediate an exchange between telecom-wavelength optical modes and microwave frequency mechanical modes; a coupling circuit including a coplanar waveguide configured to couple the superconducting circuit and the optomechanical transducer, wherein the coupling circuit is capacitively coupled to the superconducting circuit and galvanically connected to the optomechanical transducer; and one or more mitigating structures for protecting the superconducting circuit from interaction with scattered telecom-frequency photons produced at an interface between the optical fibers and the coplanar waveguide, and effects of the scattered telecom-frequency photons interacting with at least one of other materials and structures of the transducer module. Other non-limiting examples are also described.

### DESCRIPTION OF THE DRAWINGS

The scope of the present disclosure is best understood from the following detailed description of exemplary embodiments when read in conjunction with the accompanying drawings. Included in the drawings are the following figures:

FIG. 1 illustrates a block diagram of a transducer module in accordance with an exemplary embodiment of the present disclosure.

FIG. 2 illustrates a circuit for a single mode transducer module in accordance with an exemplary embodiment of the present disclosure.

FIG. 3 illustrates a circuit for a multimode transducer module in accordance with an exemplary embodiment of the present disclosure.

FIG. 4 is a graph of mode dynamics of the superconducting circuits and the optomechanical transducer circuit as a function of local magnetic flux in accordance with an exemplary embodiment of the present disclosure.

FIGS. 5A to 5C are graphs of the coupling rates estimates between the superconducting circuit and the optomechanical transducer circuit of FIG. 4 at specified frequencies in accordance with an exemplary embodiment of the present disclosure.

FIG. 6 illustrates a transducer module in accordance with an exemplary embodiment of the present disclosure.

FIG. 7 illustrates a first operating process for a TISQ transducer module in accordance with an exemplary embodiment of the present disclosure.

FIG. 8 illustrates a second operating process for a TISQ transducer module in accordance with an exemplary embodiment of the present disclosure.

Further areas of applicability of the present disclosure will become apparent from the detailed description provided hereinafter. The detailed descriptions of exemplary embodiments are intended for illustration purposes only and are, therefore, not intended to necessarily limit the scope of the disclosure.

### DETAILED DESCRIPTION

The present disclosure pertains to bridging traditionally incompatible quantum systems (or hybrid quantum systems), via a novel, exemplary transducer architectures and methodologies described herein. Examples described herein are applicable to and may be adapted for different quantum system architectures to foster improved interoperability, performance, and scalability between any type of hybrid quantum systems. Exemplary quantum system designs may comprise optimized transducer assembly configurations to enhance the conversion of quantum information between quantum processors and carriers for physical interactions, collectively carrier particle interaction. For ease of explanation, a non-limiting example of a transducer is a telecom-photon insensitive superconducting qubit (TISQ) transducer, however the present disclosure is not so limited. Non-limiting examples of quantum processors may comprise but are not limited to: any type of qubit-based designs (e.g., superconducting qubits, spin qubits, etc.) or any type of atom-based designs (e.g., trapped ions, neutral atoms, etc.), where an exemplary carrier for physical interaction may vary based on the type of quantum processor or system being utilized, including for desired frequency ranges. For instance, an exemplary carrier may be photons (e.g., telecom photons) for TISQ configuration, but points of novelty of the present disclosure are applicable to other use cases having different hardware configurations and leveraging different interaction mechanisms (e.g., spin qubit that interacts through magnetic or electric coupling). While some non-limiting examples pertain to physical devices, apparatuses, or components (e.g., quantum computing chip comprising an optimized transducer assembly), it is also to be recognized that the present disclosure further extends to overall quantum computing system design and architecture as well as systems and methods for calibration, testing, and continued optimization of exemplary transducer assembly designs as described herein including via management of quantum simulations.

Using TISQ as an example, an exemplary TISQ transducer provides a quantum interface usable to convert quantum information from a superconducting qubit (e.g., microwave signals) into optical photons in the telecom band. Using photons as an example carrier, the present disclosure provides wide applicability in improvement conversion between microwave photons and optical photons that extend beyond just telecom applications as an exemplary embodiment. The present disclosure provides advancements in quantum system configurations aid protection of the quantum processor (e.g., superconducting qubit) from being disturbed by the carrier (e.g., telecom photons), which are used in the conversion process (e.g., via carrier particle interaction), and further improving processing and transmission by maintaining coherence of a quantum system such that the quantum processor does not directly absorb or interact with the telecom photons. Further technical advantages are derived through the present disclosure including enablement of improvements in ultra-sensitive measurements (and conversions thereof), distributed quantum computing (e.g., long-distance entanglement), improved long-distance communication (including security thereof) and control management thereof, improved quantum sensing, ability for improved scaling of quantum computers, and expansion/extensibility of quantum sensing technologies, among other technical advantages.

An exemplary quantum system configuration may comprise a quantum processor (e.g., superconducting circuit), an exemplary transducer or transducer module (e.g., optomechanical transducer), and a coupling circuit. In other quantum system configurations, one or more components may vary depending on the desired configuration and practical use case. An exemplary transducer may mediate conversion of data between forms without destroying quantum properties (e.g., superposition and entanglement) such that quantum states are converted into carrier forms (and vice-versa). In the case of quantum communications, optical photons may be utilized (e.g., via fiber optics), but conversion is required as quantum processors (e.g., superconducting qubits) leverage microwave signals (e.g., microwave photons), which are sub-optimal for long-distance communication. An exemplary quantum processor may emit quantum information (e.g., quantum state information such as 0, 1, or superposition), where an exemplary transducer acts as a bridge interface to foster energy exchange while preserving quantum state information. In essence, the transducer couples the quantum processing domain with an exemplary communication domain (or communication channel), which may occur via electro-optomechanical systems, electro-optic materials, and/or atomic systems, among other examples.

Quantum system configurations (e.g., including those implemented as a quantum chip or apparatus) design may comprise one or more exemplary mitigative structures, measures or methodologies (“mitigation structures”) for preservation of and communication of quantum information including during carrier particle interactions. Exemplary mitigative structures may be implemented and/or adapted to diminish or eliminate interference with an exemplary quantum processor and be applied to one or more components of an exemplary quantum system configuration. In some examples, mitigation structures may be applied to a quantum computer itself. In other instances, exemplary mitigation structures may be part of an exemplary transducer and/or circuit component, and/or built in to an integrated quantum product (e.g., optimized quantum computing chip). In further instances, mitigation structures may be processing operations applied during operation of a quantum computing system including in real-time or in simulation. Non-limiting examples of exemplary mitigation structures and methodologies applicable under the present disclosure, individually or in aggregation, comprise but are not limited to: directional and/or distance control over transmission of carrier particle interactions (e.g., photons or phonons) relative to a quantum processor; implementation and management of exemplary coating packages (e.g., IR-absorptive coating of a sample package) for scatter control of carrier interactions (e.g., photons); design enhancements to quantum processor to improve blocking or absorption (e.g., populating a quantum processing chip with indium pillars for directing beam control); material construction and design enhancements to the quantum processor to control carrier particle interactions with quantum processor including adding of one or more coating layers or amorphous films to quantum processing chip; isolation measures and design enhancements for the quantum processor including techniques to encapsulate the quantum processor and create isolation from an intra-package space (e.g., no line of site access to electrodes via constructed multi-layer stack); and temperature control mechanisms for thermal control of circuitry components (including heating and cooling thereof); or any combination of the foregoing. Moreover, additional mitigation structures or methodologies may comprise timing control over application of described mitigation techniques or methodologies described herein. For instance, timing for manipulating direction control, adjusting temperatures (e.g., application of heating and/or cooling), may be impactful to optimizing operation of exemplary quantum systems and during carrier particle interactions. This may be derived from testing or simulation, where optimized designs of quantum systems together with optimized methods of application may continuously yield improved results.

Furthermore, the present disclosure may leverage artificial intelligence/machine learning (AI/ML) modeling to control and/or optimize quantum systems configurations, including designs for mission-specific objectives, and development of quantum computing devices and/or components such as optimized quantum computing chips. For instance, a quantum system configuration, including hardware configurations, materials, setup, calibration, simulation management, results/outputs, etc., may be managed by trained and adapted AI/ML modeling that can automate or semi-automate (e.g., for user confirmation) operations described herein to further optimize quantum system configurations and management thereof. This can aid by providing continuous enhancements and improvements to exemplary quantum system configurations and management of carrier particle interactions. For instance, users may wish to run a plurality of simulations to test/optimize quantum system configurations and methods of application for quantum communications including for long-distance communication. Trained and adapted AI/ML modeling can be utilized generate deep contextual cross-domain correlations to align with mission-specific requirements/objectives, the building of novel, contextual knowledge bases of quantum resources including for continuous adaptation and updates and output, improved methods for optimizing selection of quantum system designs, management of control parameters and/or exemplary mitigation structures, and other practical applications (e.g., quantum system fabrication, programming, software algorithms, etc.) that may leverage contextual information described herein. As a non-limiting example, AI/ML modeling may be generated, trained and adapted to manage implementation of exemplary mitigation structures (e.g., applied to quantum computing chip) determine optimal design configuration for different mission-specific objectives. In some instances, exemplary adapted AI/ML modeling may be built in or integrated into a quantum computing device or component (e.g., quantum computing chip), or otherwise utilized in conjunction with hybrid quantum computing systems for data analysis and processing of outputs from a quantum computing system.

Exemplary embodiments of the present disclosure include a telecom-photon insensitive superconducting qubit (TISQ) transducer module formed through a pairing (e.g., connecting) of plural discrete circuit elements. The exemplary transducer module disclosed herein can be constructed using modular die technology such that the circuit elements can be arranged on a modular and scalable chip design that is protected by a collection of exemplary mitigative structures. The mitigative structures can be configured to diminish and/or eliminate the poisoning of the superconducting qubit device resulting from the presence of in-situ scattered telecom photons by several modalities. Among other examples, the mitigative structures and techniques can include various structural elements and design processes that are configured to: 1) send most of the photons in a direction perpendicular to the superconducting qubit device ensuring the only photons that can reach the superconducting qubit chip are diffuse/scattered with many opportunities to be absorbed harmlessly elsewhere; 2) coat the inside of the sample-package in an IR-absorptive coating to encourage the photons to absorb into the package rather than scatter around; block/absorb the telecom photons before they reach the superconducting qubit chip in free-space by populating the chip with indium pillars designed to act as on-chip beam-blocks; 3) prevent the telecom photons from entering a telecom-transparent substrate of the superconducting qubit chip to prevent any scattered photons from illuminating the backside of the superconducting film by coating the edges of the chip in an opaque substance that is otherwise harmless to the devices; 4) build a multilayer stack over-top of the superconducting qubit to encapsulate the qubit and isolate it from the rest of the intra-package space so that any scattered photons have no line-of-sight access to the qubit electrodes; 5) form the superconducting qubit device using amorphous films which dissipate quasiparticle excitations very quickly into phonon excitations, and fabricate phonon downconverters in or on the substrate so that those phonons are rapidly dissipated out into non-pair-breaking thermal elevation; 6) use phonon band structure engineering to direct or reflect phonon excitations away from qubit structures to reduce the number of excitations that are capable of interacting with the qubit; and/or 7) use a heat-sink mechanism to thermalize all of the relevant on-chip circuitry of the transducer module and cool the elevated temperature of the transducer module resulting from the energy dissipated by the mitigative structures and techniques. An exemplary transducer module according to the present disclosure can include a superconducting qubit device that includes secondary circuitry. The superconducting qubit device can be coupled to a superconducting coupling element. The superconducting coupling element can be further coupled to a microwave-optomechanical transducer configured for microwave-to-optical signal conversion. As will be described in further detail, the TISQ transducer module includes additional features arranged in combination with the circuit elements, which allow for simultaneous, high coherence operation of the microwave and optical components by managing the distribution of photons, prevent quasiparticle production, and encourage quasiparticle recombination.

Based on the exemplary embodiments disclosed herein, the exemplary transducer module can be configured to attenuate the pair-breaking, telecom photons to prevent most of telecom photons from reaching the superconducting device. In addition, the superconducting device can be configured so that the lifetime of photon excitations that penetrate into the superconducting material is as short as possible and leave the superconducting material in the form of heat which can be coupled to the cooling power of a cryogenic fridge to cool the device as quickly as possible and maintain the lowest steady-state operation temperature at any given applied optical power.

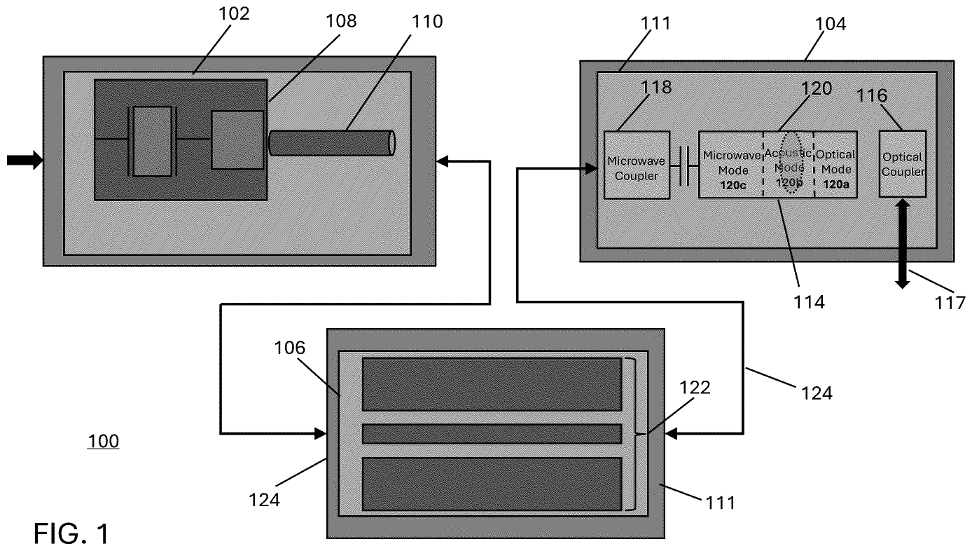

FIG. 1 illustrates a block diagram of a transducer module in accordance with an exemplary embodiment of the present disclosure.

As shown in FIG. 1, the TISQ transducer module 100 can include a superconducting circuit 102, an optomechanical transducer device 104, and a coupling circuit 106. The superconducting circuit 102 can be configured for generating qubit-state information, which is based on the qubit state determined by the number of Cooper pairs that have tunneled across a Josephson junction. According to an exemplary embodiment the superconducting circuit can include one or more qubits 108, where each qubit is formed by a resonant circuit.

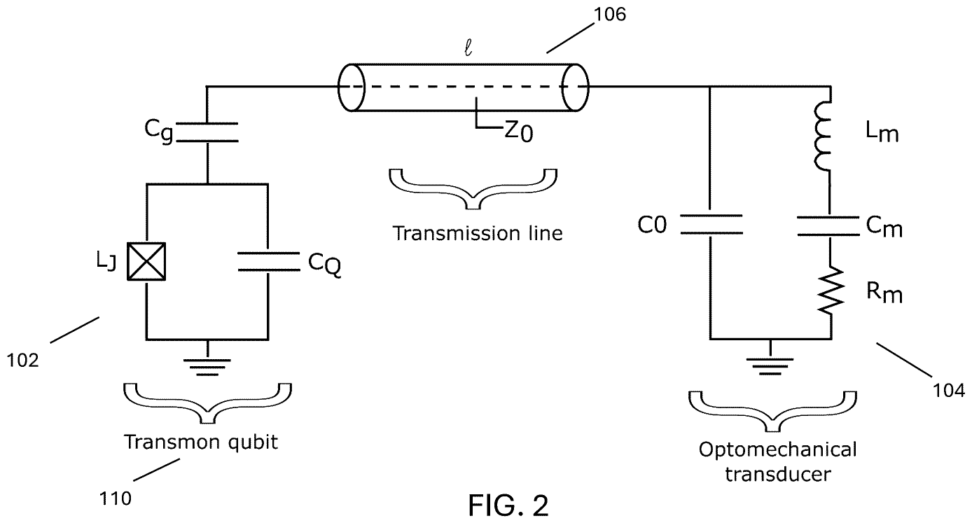

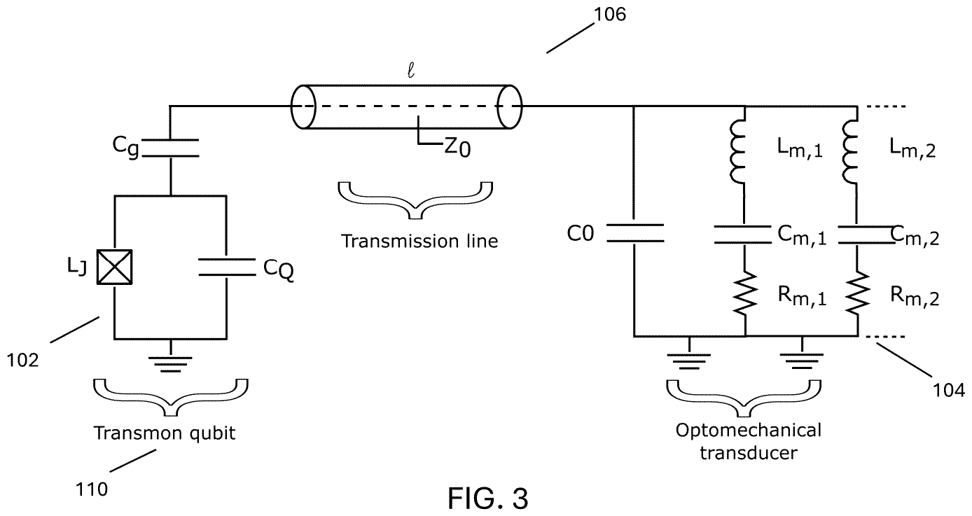

FIG. 2 illustrates a circuit for a single mode transducer module in accordance with an exemplary embodiment of the present disclosure. FIG. 3 illustrates a circuit for a multimode transducer module in accordance with an exemplary embodiment of the present disclosure. As shown in FIGS. 2 and 3, the qubit(s) 108 can be formed using a Josephson tunnel junction which includes two superconducting electrodes that are separated with a thin insulator. Through this arrangement, Cooper pairs can quantum-mechanically tunnel from one electrode to the other across the insulator (i.e., barrier). The arrangement of the Josephson junction establishes a qubit having a non-linear inductance and a capacitance which in combination form a nonlinear resonator. The Josephson junction has plural energy levels, however, the operating space of the qubit 108 is as a nonlinear resonator and can be thereby limited to the two lowest states, making it binary, and thus a quantum bit. According to an exemplary embodiment, the qubit 108 which can be configured as a flux-tunable superconducting transmon, a Cooper-pair box, a flux qubit, a fluxonium, or any other suitable qubit device as desired. The qubit(s) 108 includes a coplanar waveguide 110 with a characteristic impedance of 50 ohms. According to an exemplary embodiment, one or more qubits of the superconducting circuit 102 or combination of superconducting elements can be arranged as a fridge. The fridge can be configured to thermalize the superconducting circuit 102 and cool the superconducting circuit to base or critical temperature. According to an exemplary embodiment, Niobium can be used as the superconducting material such that critical temperature is approximately 9.2K. It should be understood that the critical temperature of the superconducting circuit 102 can vary according to the type of superconducting material used in the superconducting circuit 102.

The module 100 also includes an optomechanical transducer device 104 configured to mediate an exchange between telecom-wavelength optical modes and a microwave frequency mechanical excitation mode. The optomechanical transducer 104 can include high-overtone bulk acoustic resonators (HBARs) to generate a three-wave-mixing interaction that mediates an exchange between telecom-wavelength optical modes and a microwave frequency mechanical excitation. According to an exemplary embodiment, the optomechanical transducer 104 includes a piezoelectric component 114. When the optomechanical transducer 104 operates in the microwave frequency mechanical excitation mode, the piezoelectric component 114 is configured to interact with electrical degrees of freedom of the superconducting circuit 102 to allow direct bidirectional transduction between infrared and microwave photons. According to an exemplary embodiment, the piezoelectric component 114 can be a piezo-optomechanical transducer configured to convert the electric charge generated by the superconducting circuit 102 into mechanical energy. In accordance with the exemplary embodiments disclosed herein, the optomechanical transducer 104 can be any transducer device configured to interface between microwave-frequency electrical signals and optical signals such as an electro-optic modulator transducer, a magnon-mediated convertor, or any other suitable transducer as desired. The optomechanical transducer 104 can include an optical coupler 116 for communicating (i.e., receiving and/or sending) optical information with an external device such as another transducer, an optical switch, or a device on an optical network. The optical coupler can be connected to a fiber optic cable 117. The optomechanical transducer 104 can also include a microwave coupler 118 for sending or receiving microwave information to or from a transmission line. The optomechanical transducer also includes circuitry 120 for converting the optical energy to microwave energy, the circuitry 120 having an optical mode 120a, an intermediate acoustic mode 120b with the piezoelectric component 114, and a microwave mode 120c.

As shown in FIG. 1, the coupling circuit 106 can include a coplanar waveguide 122 and be configured to couple the superconducting circuit 102 with the optomechanical transducer 104. According to an exemplary embodiment, the coupling circuit 106 can be capacitively coupled to the superconducting circuit 102 and galvanically connected to the optomechanical transducer 104. The coplanar waveguide 122 can be configured as a

$$\frac{λ}{2}$$

superconducting coplanar waveguide (CPW) resonator. The CPW 122 can be configured to have an effective coupling strength greater than 1 MHz between the superconducting circuit 102 and the optomechanical transducer 106. The exemplary coupling strength (g_{eff}) is moderately large and allows interactions/operations between the superconducting circuit 102 and the optomechanical transducer 104 to occur within several (e.g., tens) nanoseconds. The CPW can be configured to span plural substrates (e.g., silicon chips), where the plural substrates 111 are connected for signal communication. According to an exemplary embodiment, the plural substrates 111 can be connected through a stitching process. For example, the stitching process can be achieved using known signal elevators. The coupling circuit 106 can include any superconducting coupling device configured to mediate the connection or linkage between a superconducting circuit 102 and optomechanical transducer 104 as discussed above. For example, the coupling circuit 106 can be configured to include any combination of a CPW transmission line, one or more additional superconducting qubits, or other suitable superconducting circuit which can be configured to have coupling with another device mediated via capacitive interaction or direct galvanic connection in any permutation. In addition, exemplary embodiments include a coupling circuit 106 that does not employ stitching or connecting scheme that uses signal elevator.

As already discussed, the transducer module 100 can include plural substrates 111 (e.g., silicon chips). According to an exemplary embodiment, each of the superconducting circuit 102, the optomechanical transducer 104, and the coupling circuit 106 can be deposited and/or arranged on one or more of the plural substrates 111. According to an exemplary embodiment, the transducer module 100 can include robust ground connectivity and plural impedance matched signal lines 124 arranged to connect the plural substrates 111. Based on this exemplary configuration, the transducer module 100 is suitable for 3-D signal transmission. Through robust ground connectivity and impedance matched signal lines, the transducer module 100 can be configured such that the superconducting circuit 102, the optomechanical transducer 104, and the coupling circuit 106 are spatially separated from one another and are arranged on one or more different substrates of the plural substrates 111. In addition, the one or more different substrates of the superconducting circuit 102, the optomechanical transducer 104, and the coupling circuit 106 can be arranged in different horizontal and/or vertical planes. As a result, the transducer module 100 can be configured to prevent direct acoustic/phononic communication between the plural substrates 111 on which the superconducting circuit 102, the optomechanical transducer 104, and the coupling circuit 106 are arranged.

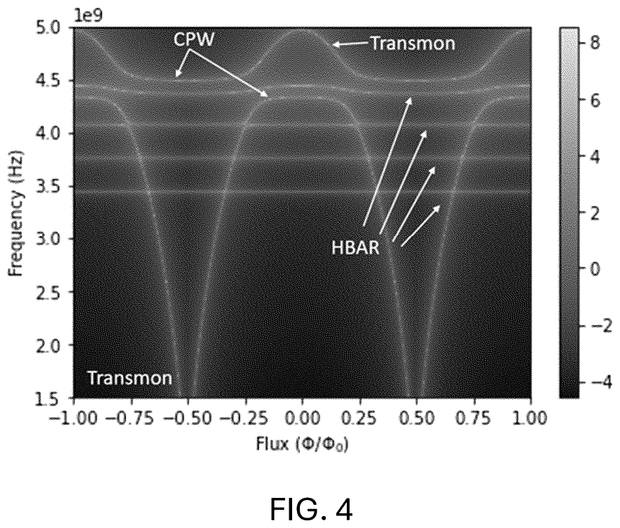

FIG. 4 is a graph of mode dynamics of the superconducting circuits and the optomechanical transducer circuit as a function of local magnetic flux in accordance with an exemplary embodiment of the present disclosure. As shown in FIG. 4, the superconducting transmon qubit 108 has its frequency swept through several (e.g., four (4)) HBAR resonator modes that interact with the transmon via a coupling that is mediated by mutual capacitance to the half-wave superconducting microwave resonator between them. FIG. 4 shows four (4) HBAR modes with 320 MHz spacing, wherein the CPW resonator is at a frequency of approximately 4.4 GHZ, and the superconducting qubits are at a frequency or approximately 5.0 GHz.

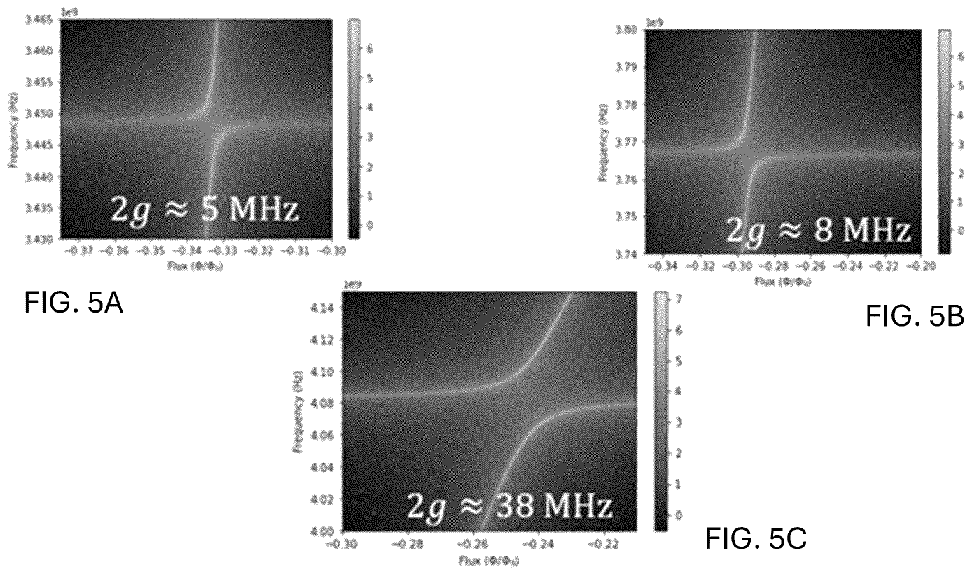

FIGS. 5A to 5C are graphs of the coupling rates estimates between the superconducting circuit and the optomechanical transducer circuit of FIG. 4 at specified frequencies in accordance with an exemplary embodiment of the present disclosure.

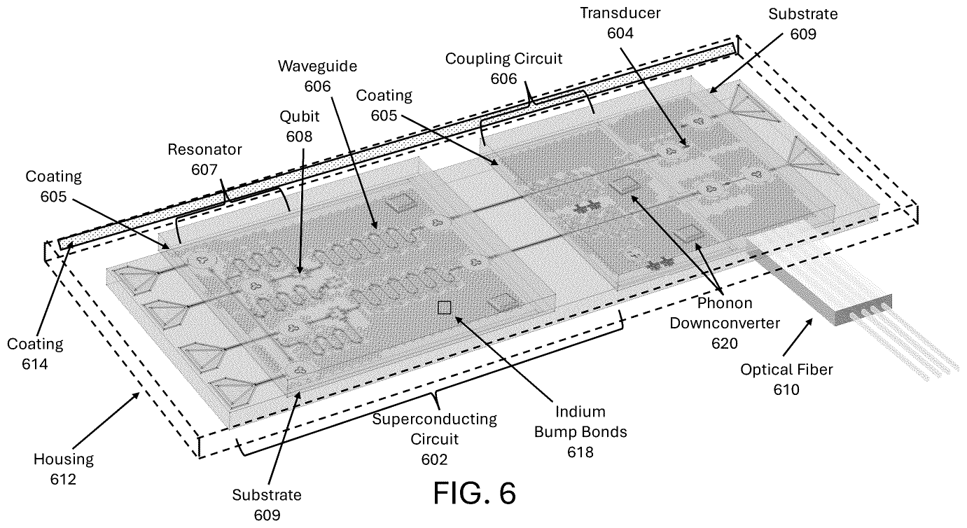

FIG. 6 illustrates a transducer module in accordance with an exemplary embodiment of the present disclosure.

As shown in FIG. 6, the transducer module 600 includes a superconducting circuit 602, an optomechanical transducer 604, and a coupling circuit 606. The transducer module 600 also includes plural substrates 609 on which the components (e.g., the superconducting circuit 602, the optomechanical transducer 604, and the coupling circuit 606) are mounted. Each substrate can be configured to have an opaque coating 605 that protects the otherwise infrared-transparent substrate from impinging scattered telecom photons by absorbing the telecom photons at the chip-edge. The optomechanical transducer 604 can include a perpendicular optical fiber bond 610 that guides incoming wave-vectors of incident light to be perpendicular to a direction of the superconducting circuit 602 to mitigate quasiparticle formation by telecom-frequency photons directed at the superconducting circuit 602. As a result, only scattered photons can reach the superconducting circuit 602. The superconducting circuit 602 can include a resonator (e.g., resonant circuit) 607 having one or more superconducting qubits 608. Because of the perpendicular optical fiber bond 610, the incoming wave-vectors are perpendicular to the superconducting qubit 608 of the superconducting circuit 602. The superconducting circuit 602 can include a coplanar waveguide 609 for passing microwave photons to/from the resonator 607. According to an exemplary embodiment, the superconducting qubit 608 can be encapsulated to eliminate a direct line-of-sight between one or more electrodes of the superconducting qubit 608 and a portion of the transducer module 600 where telecom photons are present. The superconducting qubit 608 can be encapsulated with an arrangement of high Q dielectrics and plural superconductors in a multilayer stack. For example, a multilayer stack can be built over-top of the superconducting qubit 608 to encapsulate and isolate the superconducting qubit 608 from the rest of the circuitry and components in the transducer module 600 so that any scattered photons have no line-of-sight interaction with the qubit electrodes. Encapsulating the superconducting qubit 608 can completely prevent direct qubit illumination or telecom photons from landing directly on top of the qubit electrode and ensures that the only pair-breaking excitations that can arrive on the qubit are arriving indirectly through substrate interactions. In addition, encapsulation can reduce quasiparticle lifetime can lead to reduction an average quasiparticle population in the superconducting material, thereby increasing the usability of the superconducting qubit 608. For example, the superconducting material can be configured to have robust electron to lattice coupling which results in more frequent inelastic collisions between the quasiparticles and the lattice. According to an exemplary embodiment, amorphous superconductor material (e.g., niobium nitride) can facilitate shorter quasiparticle lifetimes than crystalline superconducting material, which forces the quasiparticles to emit their energy into phonon excitations in the substrate and recombine quickly. Because of this arrangement, the average quasiparticle lifetime in the superconducting circuit 602 can be dramatically reduced over a superconducting circuit arranged or configured with more pristine metallic superconducting material as such described.

The transducer module 600 can be configured to have a housing 612 that at least partially encloses or encases the superconducting circuit 602, the optomechanical transducer 604, and the coupling circuit 606. The housing 612 can have an absorptive coating 614 that is configured to absorb infrared light and is applied to an inner surface of the housing 612. The absorptive coating can include one or more layers of an infrared-absorptive material such as castable epoxy resins, temperature curing epoxy resins, or any other suitable material for absorbing infrared light as desired. Based on this configuration, the transducer module 600 can absorb most of the telecom photons between the optical fiber bond 610 and the superconducting circuit 602. According to an exemplary embodiment, the absorbing occurs at locations remote from the one or more substrates on which the superconducting circuit 602 is mounted. The housing 612 can be configured such that the absorptive coating 614 absorbs telecom photons at a location in the transmission path that is thermally closer to a cryogenic bath of the fridge circuit 616.

The transducer module 600 can be configured such that the superconducting circuit 602, the optomechanical transducer 604, and the coupling circuit 606 (i.e., components) are mated (e.g., connected) to one or more of the plural substrates 609 using indium bump bonds 618. The indium bump bonds can be spaced apart by at least 30 microns and galvanically couple the components of the transducer module 600 to the plural substrates 609 and each of the plural substrates 609 to one or more other substrates. According to an exemplary embodiment, the indium bump bonds 618 can be as close together as is physically achievable (e.g., at least 30 microns) and as numerous as possible to create a dense arrangement of indium pillars to act as on-chip optical beam blocks. In one example, the indium bump bonds can be arranged at a spacing of at least 30 microns. In another example, the arrangement of the indium618 in specified can form a solid indium wall. The indium wall can be formed as a continuous line of indium surrounding regions of interest which can block all light from direct line-of-sight. This alternative arrangement would be used if the original arrangement proved insufficient.

According to an exemplary embodiment, the transducer module 600 can include plural phonon downconverters 620 configured to dampen or trap phonon excitations and siphon the phonon excitations away from the superconducting circuit 602. In one example, the phonon downconverters 620 can be configured to roughen and establish one or more defects on one or more of the plural substrates 609 so that the specified substrate(s) is lossy to vibrational/phononic modes. In another example, the phonon downconverters 620 can be configured to add low Tc superconducting films or film formed of normal metals to receive collisions produced by the vibrational excitations and trap or dissipate them. The phonon downconverters 620 can include surface roughening, defect doping, normal metal depositions, low Tc superconductor depositions, or any form suitable to make one or more of the plural substrates more lossy to phonons. The exemplary configuration and arrangement of the phonon downconverters 620 described herein can shorten the excitation lifetime of the phonons, which turns discrete pair-breaking excitations into a low-energy density thermal bath. Because all quasiparticles can eventually inelastically scatter or recombine and emit phonon excitations into one or more of the plural substrates and can re-break Cooper pairs, the phonon downconverters 620 are configured to damp or trap harmful phonon excitations before they reach the superconducting circuit and siphon these harmful excitations out of the transducer module 600.

The transducer module 600 can also include one or more phonon band structures configured to direct or reflect phonon excitations so that a population density of the phonon excitations is decreased on one or more of the plural substrates 609. According to an exemplary embodiment, the phonon excitations can be directed or reflected in an area proximal to the superconducting qubit 608 of the superconducting circuit 602. In one example, the area where the phonon excitations are directed or reflected can be directly underneath the superconducting qubit 608. The phonon band structures can include surface engineering, interface impedance engineering, acoustic waveguides, and any other suitable structure which can direct or reflect phonon excitations to decrease their population density in one or more areas or locations on the chip as desired.

The transducer module 600 can also include one or more heat sinks mounted to one or more of the plural substrates 609. The one or more heat sinks can be configured to wick away heat that radiates from the breaking of Cooper-pairs. In particular, the scattered telecom photons emitted in the device-environment have been converted as quickly as possible into low-energy thermal excitations which can no longer break Cooper pairs, but which elevate the device temperature. The one or more heat sinks can be arranged to better thermalize the superconducting circuit 602 to the cooling power of the coldest stage of the fridge to facilitate its cooling when energy deposited by impinging photons would otherwise heat up the device.

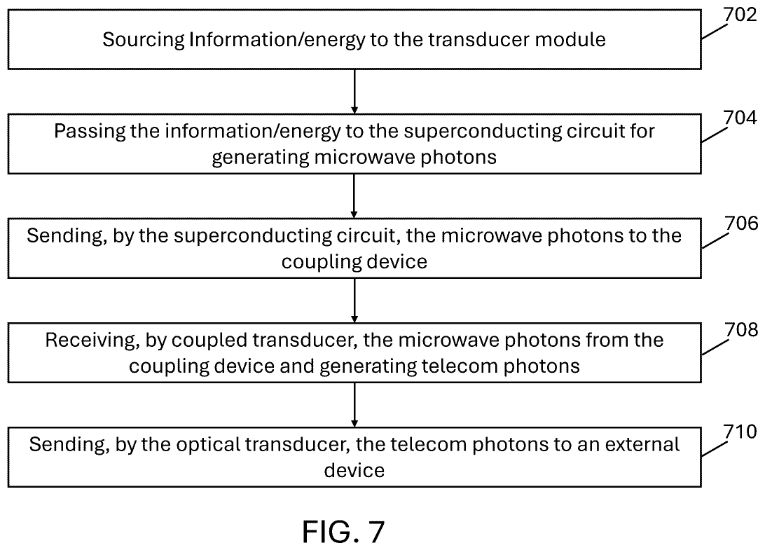

FIG. 7 illustrates a first operating process for a TISQ transducer module in accordance with an exemplary embodiment of the present disclosure.

In step 702, information/energy can be externally or internally sourced to the transducer module 600. For example, for externally sourced information/energy the transducer module 600 can include an optical fiber bond 610 arranged perpendicularly to the internal transmission path of the transducer module. The transducer module 600 can receive incoming wave-vectors and pass the information/energy is passed to the superconducting circuit 602 for generating microwave photons by exciting the qubit 608 (Step 704). The transducer module 600 passes the microwave excitations to the coupling device 606 (Step 706). The optomechanical transducer 604 receives the microwave excitations from the coupling device 606 and generates telecom photons (Step 708). The optomechanical transducer 604 then sends the telecom photons to an external device via the optical coupler 116 (Step 710).

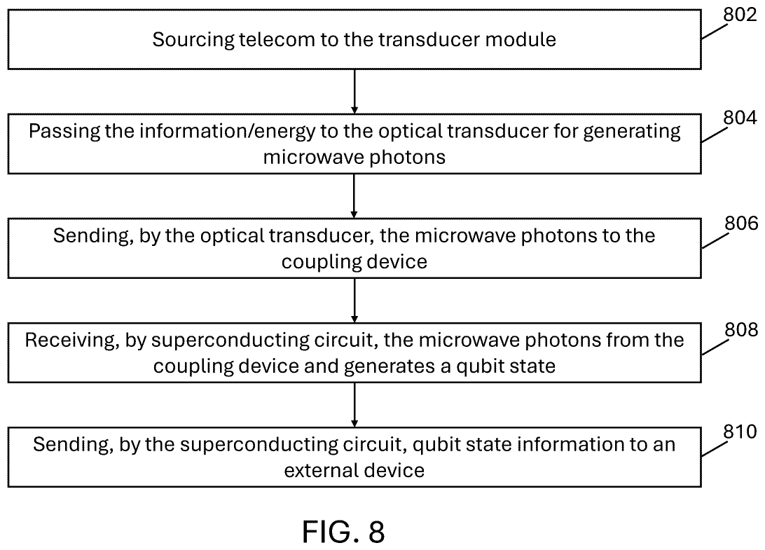

FIG. 8 illustrates a second operating process for a TISQ transducer module in accordance with an exemplary embodiment of the present disclosure.

In step 802, information/energy can be externally or internally sourced to the transducer module 600. The transducer module 600 can receive incoming wave-vectors and pass the information/energy is passed to the optomechanical transducer 604 (Step 804). The optomechanical transducer 604 generates microwave photons and passes the microwave photons to the coupling device 606 (Step 806). The superconducting circuit 602 receives the microwave photons from the coupling device 606 and generates a qubit state (Step 808). The superconducting circuit 602 sends qubit state information to an external device (Step 810).

During operation, the transducer module has plural structural elements and components which function to mitigate the exposure of the superconducting photons to telecom photons. The various structural elements and components as already discussed herein have specific functions, where applicable, of absorbing, by an absorptive coating 614, telecom photons, blocking, by plural iridium bump bonds 618, optical beams of telecom photons, damping or trapping, by phonon downconverters 620, the phonon excitations and siphoning them out of the device; directing or reflecting, by phonon band structures 622, phonon excitations so that a population density of the phonon excitations is decreased on one or more of the plural substrates 609; more effectively thermalizing, by a heat sink 624, the superconducting circuit to the cooling operation of the coldest state of the fridge.

According to the exemplary embodiments described herein, the transducer module can mitigate the poisoning of the superconducting circuit via telecom photons and their byproduct by dissipating, absorbing, and extracting photon illumination and heat which can lead to the breaking of Cooper pairs (quasiparticle production), and the shortening of the operating life of the superconducting circuit.

Embodiments of the system and method disclosed herein can use one or more AI/ML models including for control, processing, and output of quantum computers, hybrid quantum systems (e.g., quantum/classical/sensors) and/or hybrid quantum/AI/ML systems. As previously indicated, exemplary adapted AI/ML modeling may be built in or integrated into a quantum computing device or component (e.g., quantum computing chip), or otherwise utilized in conjunction with hybrid quantum computing systems for data analysis and processing of outputs from a quantum computing system. Aspects of the present disclosure can describe a unique combination of adaptive programming and data repositories as inputs, which in itself can be utilized to generate, train, and adapt AI/ML modeling for specific and practical purposes beyond what standard AI solutions. Above that, examples of the present disclosure may further transform data inputs to improve the training and usability of AI/ML modeling. For instance, quantum/quantum adjacent inputs individually or in combination can be utilized to adapt software algorithms and/or AI/ML modeling for specific technical purposes (including quantum computing applications, hybrid quantum/RF/optical systems), providing numerous technical advantages over traditional AI models. Non-limiting examples of inputs may comprise but are limited to state and hardware telemetry (e.g., quantum state and hardware telemetry) including but not limited such as qubit and/or quantum element states (e.g., such as measured expectation values, state populations, density matrices, entanglement metrics), noise and error signaling (e.g., gate error rates, readout error rates, decoherence times, crosstalk efficiencies, leakage rates), hardware telemetry (e.g., control electronics, actuators, timing/jitter, laser power, cryogenic temperature, vibration control, magnetic field readings), control and pulse-level inputs (e.g., quantum control parameters such as pulse amplitude, duration, phase, shape), microwave/RF frequency tuning/detuning, optical wavelength and/or particle management, polarization, and intensity, control channel management including timing offsets), historical control sequences, pre-processing data/post-processing data including (e.g., quantum circuit topology, qubit connectivity, cost functions, Hamiltonian definitions), measurement results (e.g., correlation matrices, confidence intervals and uncertainty estimates), simulations (e.g., Monte Carlo, approximate classical simulation, task level and mission-specific objectives as inputs (e.g., error rate tolerance, resource constrains (e.g., time, cooling, budgeting, qubit, application contents such as sensing, communication, cryptography, genome sequencing), environmental and contextual inputs (e.g., EM interference, mechanical vibration spectra, thermal parameters, network latency, co-located RF and/or optical systems), system knowledge inputs including mathematical, physics-based, quantum physics including (e.g., calibration modeling, hardware aging profiles, cross-device transfers, domain-specific information, vendor or fabrication-specific parameters, physics-based constraints), AI/ML-specific encodings, performance feedback signaling, error correction, and component adjustment, among other examples. Furthermore, the foregoing as well as any additional forms of documentation (e.g., rules, policies, standards, web-based content, network data/information, proprietary created documentation) may be leveraged to build knowledge graphs or ontology for organizational rules and policies that can help improve data ingestion and processing by AI/ML modeling (e.g., setting mixed rules, parameters), especially for building deeper contextual correlations in determining correlations [specifically for management of quantum computing systems and apparatuses, including quantum systems with optimized transducer configurations for practical applications (e.g., improving quantum communication) as described herein. This can greatly improve processing accuracy, results, noise mitigation, and reduce error rates when dealing with high levels of complexity in data parameters to evaluate, thereby setting ground rules and adding valuable context for modeling to learn and adapt in a novel way. In further examples, AI/ML modeling may be uniquely constructed to include a fusion layer that bridges broad data inputs with organizational constraints and/or satisfaction conditions to best optimize placements within those constraints or satisfaction requirements.

In some examples, exemplary AI/ML modeling can be built/generated, trained, and adapted for purposes disclosed herein. For instance, AI/ML modeling may be utilized to generate telemetry, analytics, data insights, reporting, etc., that can be leveraged for system and/or quantum computing system design (e.g., adapted transducer configurations), control parameters including components (e.g., quantum, RF, EM or a combination), testing, calibration, feedback, methods of processing including for testing re: simulation, or real-time operation, etc. This provides deep contextual insights which can be used as a base layer to build and extend novel practical applications, including adapting and optimizing component design (e.g., quantum sensor designs, interfacing with other components including transducer modules and component circuitry). In this way, the present disclosure provides an extensible and scalable solution applicable to a wide variety of practical applications including mission-specific implementations tailored for mission-specific objectives. In one example, the present disclosure may include generating and maintaining a data insights data layer that can be integrated into a data platform to interface with other components, data layers, and other integrations, whereby the data layer acts as a building block to build a layered system architecture that provides not only a queryable data repository but also a valuable data endpoint for other services to integrate with. Some key non-limiting innovative aspects by which such contextual data insights are used in the present disclosure include:
Model prediction and training. This can include generation and management of historical data points, pattern building, suggestions/recommendations. Control of quantum parameters (e.g., Hamiltonian).
Ability to adjust parameters of modeling (e.g., through admin GUI), for controlled weighting of different parameters for unique contextual scoring according tailored for optimizing objectives (e.g., sensitivity management, sensitivity/bandwidth balancing) This can include a GUI menu for selection of different scoring/ranking and comparative analytics.
Control over selection of quantum hardware and/or hybrid quantum system configurations and components.
Management of quantum process tuning (e.g., qubit tuning) including selective targeting of ranges for qubit tuning and applicable control parameters.
Management of exemplary mitigation structures and application (hardware or method/processing operations) to optimize quantum system configurations.
Quantum error correction.
Management of operating frequency bands including modeling to selectively modify/alter applicable frequency bands for desired quantum hardware configurations).
Environmental controls.
Management of networks/network layers (e.g., repeaters, routers, purification).
Creation and management of profiles including historical context/points of reference including lookup. This can be used to generate different views on profiles for micro and macro views, including drill-down menus and pop-out contextual menus to display specific contextual representations holistically or as snapshots in time.
Report building/graphing including deep contextual correlations (e.g., quantum relative to RF, EM, environmental, supporting system components of quantum computing architectures). This can include analytics and reporting at different levels and further emphasizes values and objective data driven metrics.
Ability to provide feedback on data insights to help adapt modeling.
Generating tags for data (and metadata) that can be usable for AI/ML modeling, reporting, organizationally, etc. to provide contextual enhancement and richer data insights, reporting, etc., including for specific purposes such as adapting and optimizing quantum computing systems, component design (e.g., quantum sensor designs, interfacing with other RF/EM components), management of output from quantum computing and reporting, front-end (GUI) control and reporting for quantum computing systems. For instance, unique and novel tags and metadata identifiers may be generated from results of AI/ML analysis and scoring. Such tags may be unique to the specific combination of data inputs for the AI/ML modeling to analyze. Further, the present disclosure can include the addition of tag identifiers to maintain confidentiality and secrecy in certain scenarios, including RBAC access to tags such that some custom tags are only viewable at certain levels of access or with grant of appropriate permissions.
Data insights may be generated and presented through a front-end applications/service, for example, integrated with/interfacing with exemplary systems, devices, and methods described herein for management of quantum computing systems and methods. This may include control over update of associated software algorithms and/or adapted AI/ML modeling. In further examples, searchable data repositories of data insights may be generated and presented for users. For instance, prior results and/or historical patterns from past usage can be leveraged to provide deep contextual and comprehensive results, to further optimize system management, component design and configurations, simulation management, and outputs. In additional examples, data insights may further be transmittable to mobile devices associated with an organization as notifications, where users may have configuration control over how and when notifications are surfaced.
Real-time (or near real-time) project feedback may be collected including for alerts, predictions and telemetry, data insights, process flows, data inputs, automated decision points (and/or control over manual checks, or automated/manual decision making), selective control over application of AI/ML modeling, entry of rules, preferences, etc. Such feedback may be utilized by AI/ML modeling to have model adapt and learn in real-time (near real-time). Further, feedback can be utilized to learn assignment strategies and execute simulations to play out thousands of possible predictions (e.g., success, failures). This can greatly adapt and customize AI/ML modeling applications, improve processing efficiency of underlying computing devices, and enhance accuracy and placement predictions.

Exemplary technical advantages provided by the processing described in the present disclosure comprise but are not limited to: improved quantum computing system design; improved accuracy in transducer design including optimized for practical applications (e.g., TISQ implementations); improved dynamic contextual assessment of operation of quantum computing; deeper contextual correlations and data insights pertaining to quantum computing system design and/or specific components thereof (e.g., transducer module); generation and application of novel trained AI processing that is adapted to improve operation and accuracy as well as generate predictive insights from contextual relevance analysis of inputs described herein including data sets exemplary signal data from data endpoints to integrate and interface with any organizational system data architecture; implementation of one or more trained AI/ML models (e.g., including examples of hybrid machine learning model); management of exemplary signal data of an organizational software data platform that is usable as a component, among other data sets, to intelligently adapt AI/ML in a contextual manner; automatic generation of actions and predictive data insights that are derived from analysis of exemplary data sets described herein including exemplary signal data; an improved user interface (GUI) adapted to provide front-end functionality described herein including actions, notifications, reporting, etc., to provide extensibility and usability of the present disclosure stand-alone or integrated with an organizational software data platform; improved processing efficiency (e.g., reduction in processing cycles, saving resources/bandwidth) for computing devices for sensor design evaluation; reduction in latency through efficient processing operations that improve correlation of content for adapted AI/ML applications for sensor design; improve accuracy and precision in application of trained AI/ML modeling when generating predictive outcomes; and improving usability of host applications/services for users via integration of processing described herein.

In any example described herein, adapted AI/ML described herein may be employed to analyze input data and generate predictions, classifications, data insights, or recommendations. Furthermore, one or more components may interface with AI/ML components to enable automated execution of tasks and actions to achieve practical applications described herein. As an example, a result generated by AI/ML modeling may be leveraged to trigger execution of automated decisions, raise inflection points, notifications, and modify process flow, among other non-limiting examples. Additionally, exemplary AI/ML modeling may further be integrated into a software data platform to enable data ingestion and connection to data endpoints and services which may feed critical and novel data (and metadata), including exemplary signal data, to AI/ML modeling for continuous processing. This can include continuous provision of feedback for enhanced training and adaption of AI/ML modeling as well as various types of signal data described herein that can provide customized and novel real-time (near real-time) contextual analysis of integrated applications/services.

The AI/ML models described herein may include, without limitation, supervised learning models, unsupervised learning models, reinforcement learning models, deep learning neural networks, transformer-based architectures, ensemble models, or hybrid combinations thereof. Input data may comprise but is not limited structured, semi-structured, and/or unstructured data, and further comprise any type of record or documentation including but not limited to: numerical records, categorical data, textual data, audio, video, sensor data, network activity, web pages, documents, messages e.g., text or chat), social media, historical project outcomes, knowledge graphs, and ontology. Preprocessing operations may include feature extraction, dimensionality reduction, normalization, tokenization, vectorization, embedding generation, and/or transformation into numerical representations suitable for model consumption. Non-limiting examples of types of data layers may comprise but are not limited to: raw data layers, pre-processing or clean-up layers, feature engineering or transformation layers, embedding layers (e.g., word embedding, node embeddings, latent learned features), model input layers, hidden or intermediate layers (e.g., neural network specific such as convolution layers, recurrent/temporal layers, transformer/self-attention layers), output or scoring layers (e.g., softmax, regression, ranking), post-processing layers (e.g., re-rank, weighting, filtering), and feedback or reinforcement layers (training and re-ranking based on collected signal data). Data layers may further incorporate metadata, contextual attributes, and/or weighting factors customized/defined by users.

Non-limiting examples of supervised learning that may be applied comprise but are not limited to: nearest neighbor processing; naive bayes classification processing; decision trees; random forests; gradient boosting; linear regression; support vector machines (SVM) neural networks (e.g., convolutional neural network (CNN) or recurrent neural network (RNN)); and transformers, among other examples. Non-limiting of unsupervised learning that may be applied comprise but are not limited to: application of clustering processing including k-means for clustering problems, hierarchical clustering, mixture modeling, other dimensionality reduction, etc.; application of association rule learning; application of latent variable modeling; anomaly detection; and neural network processing, among other examples. Non-limiting of semi-supervised learning that may be applied comprise but are not limited to: assumption determination processing; generative modeling; low-density separation processing and graph-based method processing, among other examples. Non-limiting of reinforcement learning that may be applied comprise but are not limited to: value-based processing; policy-based processing (policy gradient methods); and model-based processing, Q-learning, among other examples. Non-limiting examples of transformer models comprise but are not limited to: encoder-decoder architectures, attention-based mechanisms, and large language models (e.g., contextual embeddings, sequence-to-sequence learning), among other examples. Non-limiting examples of ensemble models comprise but are not limited to: combinations of classifiers or regressors (e.g., boosting, bagging, stacking), voting/aggregation (e.g., majority or weighted voting), Bayesian averaging, ensemble neural networks, snapshot ensembles, or dropout ensembles, among other examples.

Multiple AI/ML layers may be combined, wherein a rules-based layer enforces hard constraints, while a machine learning layer optimizes within permissible solution spaces. Transformer-based embeddings may be combined with clustering methods to identify latent structures in key data sets. Graph-based models may represent relationships between entities/data, while reinforcement learning layers optimize data points (e.g., assignments, roles, responsibilities) over repeated simulations.

In any AI/ML example, models are continuously trained and optimized to adapt and improve performance and accuracy. Training may comprise but is not limited to: forward propagation, backpropagation, gradient descent, stochastic gradient optimization, hyperparameter tuning, and/or automated model selection, or a combination thereof. Training datasets, validation datasets, and test datasets may be partitioned according to standard practices or dynamically adjusted based on input constraints. Loss functions may further be applied to minimize loss and improve accuracy. Loss functions may comprise but are not limited cross-entropy, mean squared error, hinge loss, cosine similarity, or domain-specific cost functions, among other examples. Weights, biases, and other parameters may be updated iteratively to minimize loss functions while maximizing predictive performance.

Additionally, AI/ML processing may comprise scoring, ranking, and weighting to optimize output. Model outputs may include raw prediction scores, probability distributions, confidence intervals, or ranked recommendation lists, among other non-limiting examples. Scoring functions may incorporate weighting factors set by administrative user, defined in documentation (e.g., internal guidelines, user-defined constraints, business rules, or supervisory input), knowledge graphs, or a combination thereof, among other examples. Ranking mechanisms may generate ordered lists of candidate outputs (e.g., classifications), optimized according to multiple objective functions. In some examples, ensemble scoring may be used, wherein multiple models contribute weighted outputs to produce a final ranking or classification.

Furthermore, AI/ML modeling is further adapted to enhance intelligible understanding and guide usage of output. Model interpretability may be enhanced using feature attribution methods (e.g., LIME), attention visualizations, or surrogate models, among other examples. Outputs may be accompanied by context, descriptions, explanations, etc. that indicate the most significant contributing factors or features, provide comparative analysis, suggestions, recommendations, etc. Human-in-the-loop feedback may be incorporated, enabling iterative retraining and calibration of model behavior. Fairness and bias-mitigation techniques may be employed, including re-weighting, counterfactual fairness testing, or adversarial debiasing.

Moreover, models may be deployed as APIs, microservices, or embedded modules within larger enterprise systems including via widgets, iFrames, etc. Real-time inference engines may support streaming data, while batch inference may be used for periodic or large-scale analysis. Models may be updated dynamically, retrained periodically, or adapted through web-based learning modules (e.g., cloud computing). Furthermore, AI/ML models described herein may be implemented using cloud-based platforms, distributed computing systems, edge devices, or hybrid architectures. Storage may be supported by relational databases, graph databases, data warehouses, or vector databases optimized for embeddings. Moreover, training and modeling may comprise a hybrid approach leveraging additional technologies and capabilities including but not limited to: plural AI/ML models, Parallelization, GPU acceleration, specialized hardware (e.g., TPUs), quantum computing, hybrid quantum/AI-ML solutions may be utilized for efficient training, inference, and acceleration of AI/ML modeling for complex problem solutions. For instance, hybrid AI/ML and quantum computing technology may be integrated and used to solve complex matters such as simulations, encryption, large-scale optimization, among other examples.

The present disclosure is further adapted to enable trained AI/ML modeling to integrate with data endpoints of applications or services (including third-party integrations) processing to collect real-time (or near real-time) signal data for improved processing efficiency, enhanced accuracy, improved training, and the adaptation of AI/ML modeling for practical applications, among other technical advantages. For instance, application of trained AI processing (e.g., one or more trained machine learning models) may be adapted to evaluate data endpoints pertaining to users within an organization (e.g., individuals, teams or project groups), signal data from data endpoints from third-party data integrations, user actions including past and/or current user actions, user preferences or settings, application/service log data, etc. This additional signal data analysis may help yield determinations for enhancing decision points and outputs, determining how (and/or when) to automate decision processing, raise notifications including recommendations/suggestions, and generation and management of data insights, among other examples. Non-limiting examples of signal data that may be collected and analyzed comprises but is not limited to: hardware or device-specific signal data collected from operation of one or more user computing devices; user-specific signal data collected from specific tenants/user-accounts with respect to access to any of: devices, login to a distributed software platform, applications/services, etc.; application-specific data collected from usage of applications/services and associated endpoints; profile data, network and/or environmental data, internal documentation (e.g., policies, guidelines, organizational values), quantum-specific state and telemetry data, third-party integrations (e.g., client apps, social media, etc.) or a combination thereof. Analysis of such types of signal data in an aggregate manner may be useful in helping generate contextually relevant determinations, data insights, etc. Analysis of exemplary signal data may comprise identifying correlations and relationships between the different types of signal data, where telemetric analysis may be applied to generate determinations with respect to a contextual state of user activity with respect to different host application/services and associated endpoints.

Additionally, the present disclosure may further comprise one or more application/service components configured to manage host applications/services and associated endpoints. The application/service component may be further configured to present, through interfacing with other computer components described herein, an adapted graphical user interface (GUI) that provides user notifications, GUI menus, GUI elements, etc., to manage front-end representation of the present disclosure including the ability to execute processing operations and methods (e.g., computer-implemented methods) described herein. An application/service component may further be configured to manage different versions or representations of the present disclosure that are packaged for user access, including management of quantum computing systems, hybrid quantum systems (e.g., quantum, RF, EM, software algorithms/AI/ML). For example, a stand-alone version of a quantum computing design app/service may be developed for testing and simulation of quantum designs including testing and simulation of optimized transducer modules and methodologies described herein (including exemplary mitigation structures), which may further be programmed to manage quantum hybrid computing systems whether design-facing, for testing or calibration, simulation management, reporting, etc. In one instance, access to an exemplary app/service may be a SaaS implementation where organizational users may access services described herein via a tenant (e.g., dedicated or shared). In other examples, the present disclosure may be integrable as a component to interface within an organizational software data platform, for instance, that can further tie into additional organizational data endpoints, among other examples, to extend use cases, and leverage data and endpoints for other mission objectives.

In any case, an application/service component further manages respective endpoints associated with individual host applications/services, which have been referenced in the foregoing description. In some examples, an exemplary host application/service may be a component of a distributed software platform (e.g., cloud computing platform) providing a suite of host applications/services and associated endpoints, services, microservices, etc. A distributed software platform is configured to providing access to a plurality of applications/services, thereby enabling cross-application/service usage to enhance functionality of a specific application/service at run-time. For instance, a distributed software platform enables interfacing between a host service related to management of a distributed collaborative canvas and/or individual components associated therewith and other host application/service endpoints (e.g., configured for execution of specific tasks). Distributed software platforms may further manage tenant configurations/user accounts to manage access to features, applications/services, etc. as well access to distributed data storage (including user-specific distributed data storage), and distributed knowledge repositories. Moreover, specific host application/services (including those of a distributed software platform) may be configured to interface with other non-proprietary application/services (e.g., third-party applications/services) to extend functionality including data transformation and associated implementation. Role-based access control (RBAC) may be implemented to manage permissions and privileges for access to data described herein.

An exemplary application/service component is further configured to present, through interfacing with computer processing devices, an adapted GUI that provides user notifications, GUI menus, GUI features, etc. The GUI may comprise interactive components such as GUI elements, dashboards, visualization panels, report generation and management, input fields for receiving user selections and parameters, and feedback, among other examples. The system may further generate and present real-time notifications, alerts, or recommendations to the GUI, including contextualized data insights derived from analytics engines or AI/ML models. Such insights may be rendered as charts, tables, or ranked lists, and may dynamically update in response to new data inputs, user actions, or system-detected events, for example, based on processing of exemplary signal data described herein. A GUI processing layer may further be implemented to support adaptive layouts, prioritization of displayed information based on relevance scores, and customizable notification preferences to enhance usability and decision-making. In further examples, a GUI is generated and adapted to manage AI/ML modeling including administrative features/functionalities and controls as described in the foregoing, all of which may further create customized, adapted, AI/ML modeling, for adapted hybrid quantum technology.

In further practical applications, exemplary AI/ML modeling may be further trained and adapted for selective control over application of resources, including adapted AI/ML modeling, to optimize processing efficiency. As an example, adapted AI/ML modeling may utilized to evaluate output from execution of quantum processing (e.g., simulated results), whereby modeling may trained to evaluate output, noise, error rates, coherence, decoherence, sensitivity, bandwidth, etc., to determine a system or components are operating correctly and as expected. In cases where there are deviations (e.g., outside of preset thresholds, ranges, scoring/confidence levels), software (e.g., AI/ML modeling) may be adapted to control operation to optimize efficiency and potentially reduce use/stress on a quantum system. For instance, there may be preset decision points (or manual notifications for review and consideration) that arise during experimentation, for determining whether to continue running an experiment (as configured), selective adjust pre-processing or post-processing data on the fly, control application of applied software programs/AI/ML modeling (e.g., stop/go, hold/pause/delay, re-run), including subsequently applied software/AI/ML etc. Developers may program and apply rule sets for selective decision control over application of adapted AI/ML modeling for optimizing efficiency in association with quantum systems and apparatuses including hybrid quantum systems and apparatuses.

It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A photon-insensitive transducer module, comprising:
optical fibers configured for communicating with an external device;
at least one superconducting circuit configured for generation, manipulation, and readout of qubit-state information;
an optomechanical transducer coupled to the optical fibers and configured to mediate an exchange between telecom-wavelength optical modes and microwave frequency mechanical modes;
a coupling circuit including a coplanar waveguide configured to couple the superconducting circuit and the optomechanical transducer, wherein the coupling circuit is capacitively coupled to the superconducting circuit and galvanically connected to the optomechanical transducer; and
one or more mitigating structures for protecting the superconducting circuit from interaction with scattered telecom-frequency photons produced at an interface between the optical fibers and the coplanar waveguide, and effects of the scattered telecom-frequency photons interacting with at least one of other materials and structures of the transducer module.

2. The module according to claim 1, wherein the superconducting circuit includes a resonant circuit and a qubit, including a coplanar waveguide with a characteristic impedance of 50 ohms, wherein the superconducting circuit is cooled below its critical temperature.

3. The module according to claim 1, wherein the optomechanical transducer is a microwave-to-optical transducer configured to generate a three-wave mixing interaction to mediate the exchange between the telecom-wavelength optical modes and the microwave frequency mechanical excitation mode.

4. The module according to claim 3, wherein the optomechanical transducer includes a piezoelectric component and in the microwave frequency mechanical mode, the piezoelectric component is configured to interact with electrical degrees of freedom of the superconducting circuit to allow direct bidirectional transduction between infrared and microwave photons.

5. The module according to claim 1, wherein the coupling circuit includes a
$$\frac{λ}{2}$$
superconducting coplanar waveguide resonator that includes capacitive coupling to the superconducting circuit and includes galvanic coupling to an electrode of the optomechanical transducer.

6. The module according to claim 5, wherein the electrode of the optomechanical transducer is a top electrode of the optomechanical transducer.

7. The module according to claim 5, wherein the superconducting coplanar waveguide extends over plural substrates.

8. The module according to claim 5, wherein an effective coupling strength between the superconducting circuit and the optomechanical transducer is greater than 1 MHz.

9. The module according to claim 1, wherein the superconducting circuit, the optomechanical transducer, and the coupling circuit are formed over plural substrates, the module including at least impedance matched signal lines.

10. The module according to claim 9, wherein the superconducting circuit, the optomechanical transducer, and the coupling circuit are spatially separated and are mounted on different substrates of the plural substrates.

11. The module according to claim 10, wherein the different substrates are disposed on different planes.

12. The module according to claim 10, wherein the one or more mitigating structures include a perpendicular optical fiber bond that guides incoming wave-vectors of incident light to be perpendicular to a direction of the superconducting circuit so as to mitigate quasiparticle formation by telecom-frequency photons directed at directed at the superconducting circuit.

13. The module according to claim 12, wherein the incoming wave-vectors are perpendicular to a superconducting qubit of the superconducting circuit.

14. The module according to claim 12, wherein the superconducting circuit, the optomechanical transducer, and the coupling circuit are arranged in a housing, wherein the one or more mitigating structures include an absorptive coating on inner surface of the housing.

15. The module according to claim 14, wherein the absorptive coating absorbs infrared light.

16. The module according to claim 14, wherein the one or more mitigating structures include plural indium bump bonds for mating components to the plural substrates.

17. The module of claim 16, wherein the one or more mitigating structures include an opaque layer that coats each of the plural substrates, the opaque layer configured to absorb telecom photons.

18. The module of claim 17, wherein the superconducting circuit includes one or more superconducting qubits, and one or more mitigating structures includes an encapsulating structure for encapsulating the superconducting qubit, the encapsulating structure configured to eliminate a direct line-of-sight between one or more electrodes of the superconducting qubit and an area within the housing containing telecom photons.

19. The module of claim 18, wherein the encapsulating structures includes an arrangement of high Q dielectrics and plural superconductors in a multilayer stack.

20. The module of claim 18, wherein the one or more mitigating structures include plural phonon downconverters configured to damp or trap phonon excitations and siphon the phonon excitations away from the superconducting circuitry.

21. The module of claim 20, wherein the one or more mitigating structures include a phonon band structure configured to direct or reflect phonon excitations so that a population density of the phonon excitations is decreased on one or more of the plural substrates.

22. The module of claim 21, wherein the one or more mitigating structures include one or more heat sinks mounted to one or more of the plural substrates.
